(19) United States
(12) Patent Application Publication
(10) Pub. No.: US 2020/0242540 A1
(43) Pub. Date: Jul. 30, 2020

(54) PREDICTING A WORK PROGRESS METRIC FOR A USER

(71) Applicant: INTERNATIONAL BUSINESS MACHINES CORPORATION, ARMONK, NY (US)

(72) Inventors: Leonardo Rosati, Rome (IT); Michele Crudele, Rome (IT); Antonio Perrone, Rome (IT)

(21) Appl. No.: 16/261,852

(22) Filed: Jan. 30, 2019

(51) Int. Cl. G06Q 10/06; G06N 20/00

(52) U.S. Cl. CPC G06Q 10/063118; G06N 3/08; G06N 20/00

(57) ABSTRACT

The invention relates to a computer-implemented method for predicting a work progress figure for a user using an assignment test. Receiving an input activity record; receiving an input sequence of activity records; generating a test sequence comprising the input activity record appended to the input sequence; providing the test sequence to an input of a machine learning model; in response to the provision of the test sequence, receiving a metric from an output of the machine learning model, the metric comprising a work progress figure assigned to the test sequence; and providing the metric, the method further comprising: receiving an unassigned activity record specific to the user; receiving a task specific to the user, the task comprising a sequence of assigned activity records; and executing the assignment test with the input activity record being the unassigned activity record and the input sequence being the sequence.

### BACKGROUND

The present invention relates to automatic prediction of a user-specific work progress metric and automatic recording of a dataset characterizing work.

### SUMMARY

In one aspect, the invention relates to a computer-implemented method for predicting a work progress figure for a user utilizing an assignment test. The method comprises receiving a first input activity record; receiving an input sequence of activity records; generating a test sequence, the test sequence comprising the input sequence and the first input activity record appended to the input sequence; providing the test sequence to an input of a machine learning model; receiving a metric from an output of the machine learning model in response to the provision of the test sequence, the metric comprising a work progress figure assigned to the test sequence; and providing the metric.

In the computer-implemented method, the metric further comprises receiving a first unassigned activity record specific to the user; receiving a first task specific to the user, the first task comprising a first sequence of assigned activity records; and executing the assignment test with the first input activity record being the first unassigned activity record and the input sequence being the first sequence.

In another aspect, the invention relates to a computer-implemented method for recording an activity of a user using software. The method comprises executing a process for recording an activity record characteristic of the usage, the activity record comprising at least the following: an identity of the user, a start timestamp representing a beginning of the usage, a duration figure associated with a time period of the usage, an activity descriptor characteristic of the usage, an activity type characteristic of the software, and an artifact record, the artifact record comprising an artifact descriptor representing an input to or an output of the software during the usage, and an artifact type representing a data type or an operation type associated with the input or output represented by the artifact descriptor; and providing the activity record, in response to the ending of the usage.

In a further aspect, the invention relates to a computing system comprising a processor and a memory, the memory storing computer-executable instructions which, when executed by the processor, cause the processor to execute a method utilizing an assignment test for predicting a work progress figure for a user. The method comprises receiving a first input activity record; receiving an input sequence of activity records; generating a test sequence, the test sequence comprising the input sequence and the first input activity record appended to the input sequence; providing the test sequence to an input of a machine learning model; receiving a metric from an output of the machine learning model in response to the provision of the test sequence, the metric comprising a work progress figure assigned to the test sequence; and providing the metric.

The computing system further executes a method, the method comprising receiving a first unassigned activity record specific to the user; receiving a first task specific to the user, the first task comprising a first sequence of assigned activity records; and executing the assignment test with the first input activity record being the first unassigned activity record and the input sequence being the first sequence.

In yet a further aspect, the invention relates to a computer program product, in particular a computer-readable medium, the computer program product carrying computer-executable instructions for execution by a processor controlling an apparatus, wherein execution of the instructions causes the processor to execute a method for predicting a work progress figure for a user utilizing an assignment test. The method comprises receiving a first input activity record; receiving an input sequence of activity records; generating a test sequence, the test sequence comprising the input sequence and the first input activity record appended to the input sequence; providing the test sequence to an input of a machine learning model; receiving a metric from an output of the machine learning model in response to the provision of the test sequence, the metric comprising a work progress figure assigned to the test sequence; and providing the metric.

The computer program product further executes a method. The method comprises receiving a first unassigned activity record specific to the user; receiving a first task specific to the user, the first task comprising a first sequence of assigned activity records; and executing the assignment test with the first input activity record being the first unassigned activity record and the input sequence being the first sequence.

Embodiments of the invention are given in the dependent claims. Embodiments of the present invention can be freely combined with each other if they are not mutually exclusive.

### BRIEF DESCRIPTION OF THE SEVERAL VIEWS OF THE DRAWINGS

In the following, embodiments of the invention are explained in greater detail, by way of example only, making reference to the drawings in which:

FIG. 1 depicts a schematic environment adapted for implementing the method for predicting a work progress figure for a user and the method for recording an activity of a user.

FIG. 2 depicts a representation of an exemplary activity record and an exemplary artifact data structure embedded in the activity record.

FIG. 3 is a flow diagram representing steps of the assignment test.

FIG. 4 is a flow diagram representing steps for recording an activity of a user.

FIG. 5 illustrates a workflow for recording activity data and its evaluation using the machine learning model.

FIG. 6 illustrates a task association phase for an exemplary activity record.

FIG. 7 illustrates an assignment phase for an exemplary activity record.

### DETAILED DESCRIPTION

During the last decades, project management technology has developed from a voice-communicated status, where, for example, a developer or tester talked to the project manager to update their tasks, to a software-supported way of updating the status. Especially in the context of IT projects it is observed however that task datasets in a virtual project management environment are often not regularly or adequately updated with their real status.

A widespread approach to task updating requires that the developer has to proactively conduct a “manual” activity (voice note, email, login to a project management software) in order to periodically (e.g. daily) adjust the progress of a task and thus help the project manager to keep track of the actual project status. For each task, the number of manual updates can become large (e.g. 20% done, 70%, back to 30%, 50%, 80%, 90%, 95%, 99%, finished), and also psychosocial barriers may prevent a user from updating a task regularly. As a result, it may occur frequently that the status of tasks is out-of-date.

Modern project management solutions provide a user participating in a project with a task repository where working tasks assigned to that user are collected. These tasks are typically provided with a task-specific progress figure (e.g. a percentage) which has to be kept up-to-date by the user manually, using knowledge about the activities which have to be performed to complete a given task. It would be desirable to have a solution which automatically captures and interprets the progress of work to provide a quantitative estimation of a user's progress and thus assist the user to focus on the working activities.

The method for predicting a work progress figure for a user involves characteristic data structures which include task datasets (or “tasks” in short) and activity records (“activities”). An activity record is a dataset which has been automatically recorded according to the method for recording an activity of a user and comprises details of a personal usage of a predetermined, dedicatedly monitored piece of software. The recording process (which will be called “sensor” herein) runs on the workstation computer used by the user to work on the task, preferably as a background process such as a service, a daemon, a plugin, etc. The workstation may differ from the machine executing the monitored software, e.g. when using a server- or cloud-hosted application. Preferably, an activity record is received from the output of the process according to the method for recording an activity of a user.

A task is a user-specific dataset which comprises at least partially human-readable descriptive information about an item of work to be accomplished by the user. Descriptive information may include a task title and description, a deadline, an identifier of the user to which the task is assigned (the “task owner”), links to data resources, included data objects (e.g. file attachments), etc.

For the scope of the present invention, a task is additionally provided with a sequence of activity records which have been assigned to said task in the past. For a given task, the sequence of assigned activities forms the progress of work to which a work progress figure can be assigned. Preferably, the sequence of assigned activities is ordered by a representative timestamp of each activity (e.g. starting time or ending time).

As the user uses software to work on the task, one or more sensors record one or more new activities, which may form a sequence again due to the time-linear nature of work (unless e.g. automatic calls to subroutines are recorded concurrently). The sensors send the newly recorded activities to a central server hosting a process which controls the assignment test and potential further assignment and association procedures according to embodiments.

On a basic level, the method for predicting a work progress figure for a user provides an assignment test which utilizes a machine learning model to predict an assumed work progress figure (e.g. a percentage) for a test sequence of activity records. The test sequence is generated by appending a newly recorded activity record whose task assignment is unknown (the first unassigned activity record) to a sequence of activity records (the first sequence) which were previously recorded and assigned to a given task (the first task).

The work progress figure thus obtained is specific to the tested combination of the first unassigned activity record and the first task represented by the first sequence. For each tested combination, the work progress figure may be stored for further processing, e.g. in a dedicated central database or as a new dataset entry in the task which was tested.

As an advantageous technical effect, the method for predicting a work progress figure for a user may allow to assign a work progress figure to a task without the necessity of user interaction. Whereas the progress of work is traditionally subject to human estimation based on personal knowledge of the working process, and is thus not accessible to automation, the present method utilizes the novel datatype of an activity record as a source of automation. The method further utilizes a machine learning model assign a work progress figure, i.e. a number, to a sequence of activity records, i.e. a highly nonlinear data structure of usually mixed numerical and non-numerical content which is not accessible to arithmetic calculation. In this way, a sophisticated estimate of work progress can be obtained based on real-time data representing the actual work flow.

Preferably, but not exclusively, the machine learning model is a recurrent neural network (RNN). In an initial configuration, standard values (representing a historical standard training set) may be loaded for the coefficients of the machine learning model. However, these can be replaced by user-specific values obtained by re-training the model using a user's feedback on the work progress figure, as will be explained in more detail further below. User-specific coefficients may also be stored in a central database. In this way, usage of a machine learning model may offer a high customizability, and hence an improved estimate of work progress for each user.

The present invention relates to some peculiarities which are noted in the following. If a user has not started to work on a specific task, the sequence of activity records assigned to this user's task may be empty. However, it is also possible that an empty sequence is pre-filled with activity records which were recorded from automatic software processes which took place without any user interaction. In this case, a task's sequence already contains one or more activity records, although the user has not started to work on that task.

Tasks may be hosted within a task repository by a task management or productivity software, system, or environment. If a user has not been assigned to any tasks, that user's task repository is empty. If an activity record is scheduled for an assignment test on an empty task repository, the method for predicting a work progress figure for a user may be enforced by automatically creating a new, empty task with which the activity can be associated. Alternatively, a starting condition may be established which allows for skipping the method until the task repository is populated.

For the scope of the current disclosure, it shall be noted that the terms “assign” or “assignment” have a distinct meaning from the terms “associate” or “association”, respectively: An activity record can be associated with a task based on the output of the machine learning model. Hence, an association is a sophisticated suggestion by an inference engine which has not been confirmed by a human. If a user subsequently decides to confirm the association for a given activity record, or inputs a different task to which the given activity record belongs in the user's opinion, this confirmation is called an assignment which is considered as correct.

According to embodiments, the metric further comprises a probability of correct association of the first input activity record with the input sequence. A probability of correct association (also called “correctness probability” and “probability of correctness” herein) may be useful e.g. for ranking or sorting the possible assignments of a new activity record and may serve as a basis for further numerical analysis.

According to embodiments, the user has assigned a task repository, the task repository comprising the first task and at least one second task, each second task comprising a second sequence of assigned activity records, the method for predicting a work progress figure for a user further comprising utilizing a task association, the task association comprising:

receiving a second input activity record;

determining a most likely task out of a first group formed by the first task and the at least one second task, wherein for the sequence of assigned activity records of the most likely task the probability of correct association of the second input activity record is highest; and

associating with the most likely task the second input activity record and the work progress figure received for a combination of the most likely task and the second input activity record,

the method for predicting a work progress figure for a user further comprising:

for each second task, receiving the second task and executing the assignment test with the first input activity record being the first unassigned activity record and the input sequence being the second sequence; and

executing the task association with the second input activity record being the first unassigned activity record.

For the scope of the present invention, a task repository is understood as a personal record or list assigned to one specific user. A task repository may be empty or contain one or more tasks.

The task association procedure compares the probabilities of correctness which were received from the output of the machine learning model for combinations of the input activity record with different activity sequences (tasks). Eventually, the input activity record is associated with the task which has a highest correctness probability (the most likely task), together with the corresponding work progress figure which was obtained for the combination of the input activity record with said most likely task. Therefore, application of the task association procedure may have the advantage of providing an automatic mechanism for assigning a user activity to a task dataset without a dedicated user input. In this way, a more reliable and up-to-date set of work progress figures may be obtained.

Several possibilities exist if the criterion of a highest probability of correct association is met by more than one combination for the activity record in question (“ambiguous association”). This may be the case e.g. if decimal places are rounded, a categorization into probability categories is implemented, or a similarity threshold rule is implemented (e.g. “associate only if the two highest probabilities differ by at least 5%”). According to embodiments, in case of an ambiguous association, the association is skipped, and optionally both possibilities are presented to a user to enable a correct assignment. According to alternative embodiments, in case of an ambiguous association, a supplementary analysis of both tasks and/or the input activity record is conducted to identify hints for a more probable assignment (e.g. one task may have the same project identifier as the input activity; an ending timestamp of the latest assigned activity in the sequence is later than the other or lies within a predetermined period of e.g. three days; etc.)

The association of the work progress figure may be stored as part of the most likely task without replacing any earlier work progress figure which may be present in the most likely task dataset. Likewise, the associated dataset does not necessarily have to be appended to the sequence of assigned activities of the most likely task. This may facilitate restoring the original task in case of a subsequent assignment of the activity to another task.

A user interface may display a task which comprises one or more associated activities in a different manner (e.g. using a color code, icons, etc.) as tasks which have been properly assigned. This may provide to the user a hint about the reliability of the work progress figure which is displayed alongside the given task.

According to embodiments, the association of the second input activity record and the work progress figure with the most likely task is performed only in case the probability of correct association of the second input activity record with the most likely task is greater than or equal to a predetermined threshold value.

This threshold value may represent various situations when attaching a new activity to an existing task is not feasible, e.g. if the new activity belongs to a task which has not yet been submitted to the task repository, or if a special task requires an unusual working approach which is not reflected by the coefficients used by the trained machine learning model. Skipping the association may therefore enable a dedicated handling of such unusual activities, e.g. allowing to incorporate a user assignment of the activity into a training set of the machine learning model at a later time.

According to embodiments, the user has assigned an activity repository, the activity repository comprising the first unassigned activity record and at least one second unassigned activity record, the method for predicting a work progress figure for a user further comprising utilizing an activity association, the activity association comprising:

receiving an unassociated activity record;

for each task out of the first group formed by the first task and the at least one second task, receiving the task and executing the assignment test with the first input activity record being the unassociated activity record and the input sequence being the sequence of assigned activity records comprised by the task;

executing the task association with the second input activity record being the unassociated activity record; and

in response to associating the unassociated activity record, removing the unassociated activity record from the activity repository,

the method for predicting a work progress figure for a user further comprising:

in response to associating the first unassigned activity record, removing the first unassigned activity record from the activity repository; and

for each second unassigned activity record, performing the activity association with the unassociated activity record being the second unassigned activity record.

This may have the advantage of providing an estimated task progress figure for e.g. all activities in the repository or merely a subset defined by selection of the first and second activities.

According to embodiments, the first unassigned activity record and each second unassigned activity record further comprise a timestamp, the method for predicting a work progress figure for a user further comprising in response to completing the activity association for a second group formed by the first unassigned activity record and each second unassigned activity record, in case the activity repository comprises one or more remaining activity records out of the second group:

generating a sample task in the task repository;

using the timestamp for determining an earliest one of the remaining activity records;

assigning the earliest remaining activity record to the sample task;

executing the assignment test with the first input activity record being the earliest remaining activity record and the input sequence being an empty sequence;

removing the earliest remaining activity record from the activity repository; and

in response to the removal of the earliest remaining activity record, for each remaining activity record in the activity repository, executing the activity association with the unassociated activity record being the remaining activity record.

It may occur that one or more activity records out of the second group remain in the activity repository after having gone through all activities of the second group. This may be the case e.g. if an association was skipped due to an insufficient association probability (as described further above). The generation of a sample task with subsequent execution of the activity association for all remaining records may ensure that no activity is left unassigned. Further, this may enable to achieve a common association of more than one activities which belong to a same task which is not yet present in the task repository.

According to embodiments, the first unassigned activity record and each second unassigned activity record further comprise a timestamp, the method for predicting a work progress figure for a user further comprising using the timestamp for selecting an earliest one of the activity records in the activity repository as the first unassigned activity record, the performance of the activity association being executed in ascending temporal order of the second unassigned activity records, wherein the unassociated activity record is the second unassigned activity record.

This may ensure that, when an associated activity is finally assigned to a given task, the sequence of assigned activities of that task remains in temporal order.

According to embodiments, the method for predicting a work progress figure for a user further comprises:

submitting a summary of the task association of the first unassigned activity record to the user, the summary being descriptive of the first unassigned activity record and an associated task associated with the first unassigned activity record;

waiting for receiving a first verification information from the user, the first verification information being descriptive of an assignment of the first unassigned activity record to an assigned task;

in case of receiving the first verification information with the assigned task differing from the associated task, re-associating the first unassigned activity record with the assigned task;

appending the first unassigned activity record to the sequence of assigned activity records comprised by the associated task; and

assigning the work progress figure received for a combination of the sequence of assigned activity records comprised by the associated task and the first unassigned activity record to the associated task.

According to embodiments, the method for predicting a work progress figure for a user further comprises:

submitting a summary of the assignment test to the user, the summary being descriptive of the first unassigned activity record, the first task, and the work progress figure received for a combination of the first sequence and the first unassigned activity record;

waiting for receiving a second verification information from the user, the second verification information being descriptive of an assignment of a subjective progress figure to the combination of the first sequence and the first unassigned activity record;

in case of receiving the second verification information with the subjective progress figure differing from said work progress figure, updating said work progress figure to the value of the subjective progress figure.

User notifications may provide the user with the possibility to review the task and activity associations which were automatically suggested using the machine learning model. The summary may be provided by any means of notifying a user, including without limitation an e-mail message, a journal listing the first and second tasks together with their assigned and/or associated work progress figures and activities, and a message displayed on an output device of a user interface. Notifying the user may improve data quality of the tasks further by turning preliminary associations into definitive assignments and providing a verified, mind-based work progress figure which may reflect the actual progress of work better. Additionally, the notification may serve as a reminder for the user and thus prevent the user from skipping personal task progress reporting duties.

If a suggested association is acceptable to the user, the user may simply accept an individual association or all associations included in the summary, e.g. by clicking an “Accept” button or the like. The user may also choose to review the associations later, e.g. by clicking a “Defer” button or the like. A user interface may include further input elements like slide controls to facilitate adjustment of the suggested associations. It may further include project management control elements, e.g. a “New” button for creating a new task, “X” buttons for canceling individual activity associations, object drag handles for rearranging graphical representations of tasks and/or activities, etc.

It may be possible that a reported activity is not associated with a task, e.g. if the association step was skipped as described before. In this case, the associated task is empty and the summary may display e.g. an identifier of the respective activity record together with a status “Assigned task: none” or the like.

According to embodiments, the user has assigned a task repository, the task repository comprising the first task, the method for predicting a work progress figure for a user further comprising, in response to the update of the work progress figure received for a combination of the first sequence and the first unassigned activity record, receiving one or more training tasks from the task repository, the training tasks comprising the first task, and executing a learning algorithm on the training tasks for generating an updated machine learning model.

This may improve the quality and accuracy of predictions delivered by the machine learning model. User-specific coefficients of the re-trained model may be stored as replacing former coefficient sets, or e.g. as a versioned coefficient dataset parallel to a former dataset to enable restoration of the model.

According to embodiments, the user has assigned a task repository, the method for predicting a work progress figure for a user further comprising, in case the task repository is empty, generating a new task in the task repository, the new task comprising an empty sequence of activity records, the receipt of the first task comprising identifying the new task as the first task.

In this case, the test sequence comprises only the first activity record and the work progress figure is determined based solely on the first activity record. This may ensure operability of the method in the case that the user is working without having been assigned a task.

According to embodiments, the user has assigned a task repository, the method for predicting a work progress figure for a user further comprising, in case the task repository comprises only the first task, associating the first unassigned activity record and the work progress figure with the first task.

According to embodiments, the metric further comprises a probability of correct association of the first input activity record with the input sequence, the association being performed only in case the probability of correct association of the first unassigned activity record with the first task is greater than or equal to a predetermined threshold value.

If the task repository comprises only one task, it may be beneficial to skip further association and evaluation procedures to increase efficiency of the method for predicting a work progress figure for a user. However, there may be an additional advantage in skipping the association if the recorded data do not allow a plausible association.

According to embodiments, the method for predicting a work progress figure for a user further comprises delaying the execution of the assignment test until a starting condition is fulfilled. The assignment test may be executed according to a schedule or on a regular base (the starting condition is a time relation, e.g. “every night at 3:00 AM” or “every 48 hours”), or the starting condition may relate to further relevant data such as the activity repository (e.g. “start testing when the number of recorded activities is at least 30”).

According to embodiments, the machine learning model comprises a recurrent neural network. This type of machine learning model may be especially suitable for predicting a work progress figure for a user as it is capable of evaluating an item to be evaluated (the first unassigned activity record) based on not only its current coefficients, but also, if present, items logically preceding the item to be evaluated (the assigned activity records of the input sequence).

The method for recording an activity of a user may beneficially provide the ability to automatically collect and provide empirical data which are characteristic of the activity actually performed by the user. The process preferably monitors the software application in the background (e.g. as a service, a daemon, or a plugin to an IDE, a browser, etc.) such that no user interaction is required for characterizing the usage process. The process (the “sensor”) is preferably hosted by the user's workstation. The workstation may host multiple sensors, wherein each sensor is dedicated to monitoring a different software application. Depending on the nature of the software application, it may be more feasible to run a single sensor for monitoring multiple different interactions of the user with the application, or alternatively, to run one sensor for each interaction of interest with the same application. The recorded activity record may preferably be provided as an input to the method for predicting a work progress figure for a user.

A duration figure may be, for instance, a stop timestamp representing an ending of the usage, or a duration period representing a time difference between the beginning and the ending of the usage.

According to embodiments of the method for recording an activity of a user, the software comprises one of the following: an integrated development environment, an application programming interface, a graphical user interface builder, a compiler, a software testing tool, a debugger, a code profiler, a modeling tool, a shell, a version control software, a web browser, a word processor, an email client, a social media client, and a collaboration tool.

This may increase the flexibility of the method for recording an activity of a user, allowing to provide a selection of sensor processes which are tailored to the characteristics of the work performed by the user. The given list of software applications may be especially comprehensive for collaborative IT projects such as software development.

According to embodiments, the method for recording an activity of a user further comprises generating a multiplicity of activity records by repeating the recording for a multiplicity of usage events of the software, and merging the activity records into a merged activity record, the provision of the activity record comprising providing the merged activity record.

This may provide the advantage of reducing the workload of a downstream process such as the method for predicting a work progress figure for a user described herein.

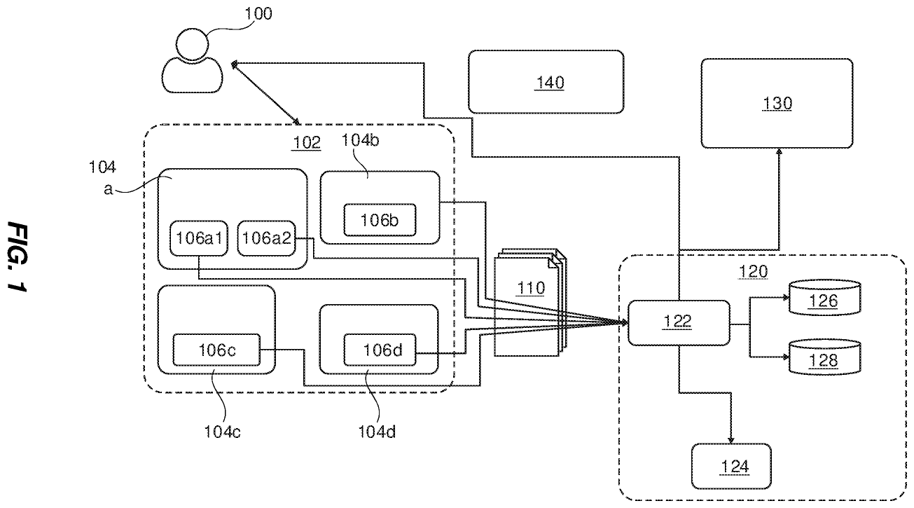

FIG. 1 is a schematic representation of a computing environment which is adapted for implementing the method for predicting a work progress figure for a user 100 and the method for recording an activity of a user 100. The user 100 is working on a workstation 102, wherein the working comprises using several software applications 104, in the example shown an integrated development environment (IDE) 104a, an internet browser 104b, a collaboration tool 104c (e.g. slack), and an e-mail client 104d. Two sensor processes 106 are monitoring the IDE 104a: one senor 106a1 monitoring usage of the versioning tool git, and one sensor 106a2 monitoring a code editor of the IDE. Sensor 106b monitors general browsing activity using the internet browser 104b, sensor 106c monitors general activities using the collaboration tool 104c, and sensor 106d monitors general activities using the e-mail client 104d.

The sensor processes 106 collect data descriptive of the monitored activities in activity records 110 and provide them to server 120. Server 120 runs an inference engine server process 122 executing the method for predicting a work progress figure for a user. The inference engine provides training datasets to an analytics engine 124 running on the server and operates a user activity storage 126 (e.g. a database) for storing activities and/or activity repositories for one or more users as well as a user task storage 128 (e.g. a database) for storing tasks and/or task repositories for the one or more users. The analytics engine 124 runs periodically or triggered by e.g. a user request or a training condition such as a schedule or a predetermined minimum number of training datasets having been collected the inference engine.

The inference engine 122 interoperates with an external issue or task tracking system 130 (e.g. GitLab, JIRA, RTC) e.g. to receive new tasks to which activities can be assigned or to update existing tasks according to the associations and assignments obtained during execution of the method for predicting a work progress figure for a user. The inference engine further provides notification summaries of said associations to the user 100 using a notification means 140 (e.g. a graphical user interface, an e-mail system, or an collaboration system such as slack). The inference engine receives assignments and confirmations of associations from the user 100 via the notification means 140.

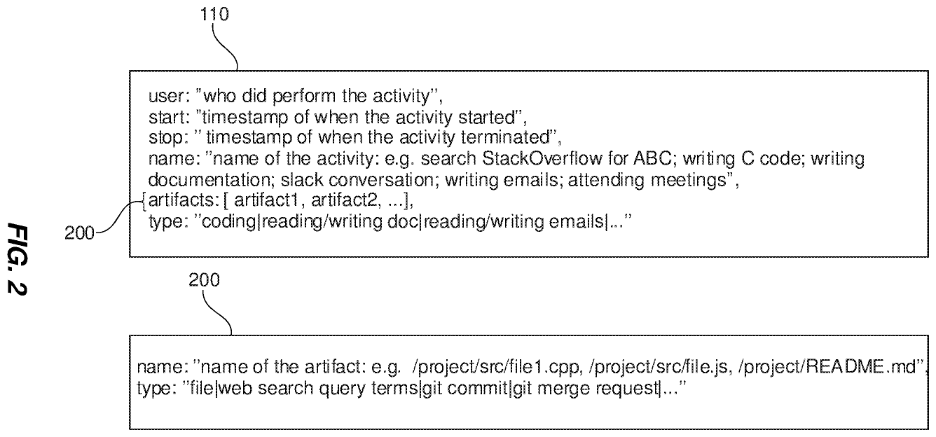

FIG. 2 shows a schematic overview of content of an exemplary activity record 110. The activity record 110 comprises an identity of the user, a start timestamp representing a beginning of the recorded usage, a duration figure associated with a time period of the usage (a stop timestamp in the drawing), an activity descriptor characteristic of the usage (e.g. “search StackOverflow for ABC”; “writing C code”; “writing documentation”; “slack conversation”; “writing emails”; or “attending meetings”; etc.), an activity type characteristic of the software (e.g. “coding”; “reading/writing documentation”; “reading/writing e-mails” etc.), and one or more artifact records 200. The artifact record 200 comprises an artifact descriptor representing an input to or an output of the software during the usage (e.g. “/project/src/filel.cpp”; “/project/src/file.js”; “/project/README.md”; etc.), and an artifact type representing a data type or an operation type associated with the input or output represented by the artifact descriptor (e.g. “file”; “web search query terms”; “git commit”; “git merge request”; etc.).

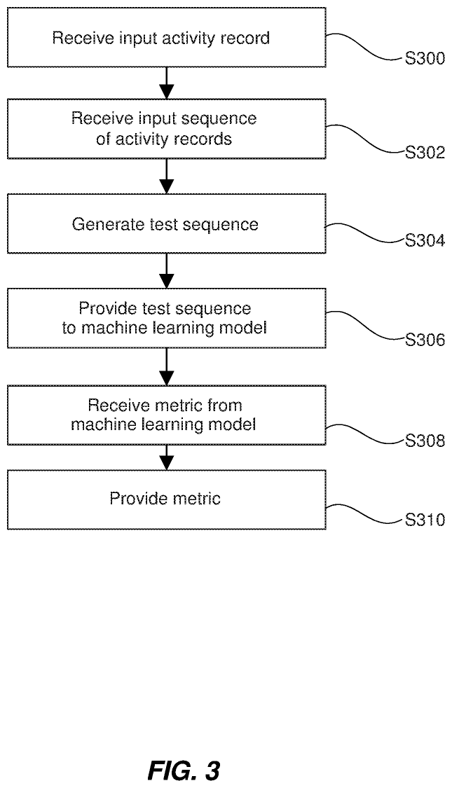

FIG. 3 is a flow diagram representing steps of the assignment test according to an embodiment of the method for predicting a work progress figure for a user. The steps shown in FIG. 3 may be performed as a server process running on a server. # Embodiments of the method comprise receiving an unassigned activity record and a task, wherein both are specific to the user. The task comprises a sequence of zero, one or more assigned activity records. Once received, the method further comprises executing the assignment test with the input activity record being the unassigned activity record and the input sequence being the sequence of assigned activity records.

The assignment test starts with receiving (S300) an input activity record, which is the user's unassigned activity record in the embodiment given above, and receiving (S302) an input sequence of activity records, which is the sequence of assigned activity record of the user's task in the embodiment given above. The input activity record is appended (S304) to a copy of the input sequence, wherein the appended copy defines a test sequence. The test sequence is provided (S306) to an input of a machine learning model which is initialized in a trained configuration according to a standard training set or a user-specific training set. If a user-specific configuration is loaded, the standard training set may be a subset of the user-specific training set.

In response to processing the test sequence by the trained machine learning model, a metric is received (S308) from an output of the machine learning model. The metric comprises a work progress figure (e.g. a percentage) which is specific to the tested combination of the input sequence and the appended input activity record. The metric is provided (S310) e.g. for subsequent storage and/or processing by the server process.

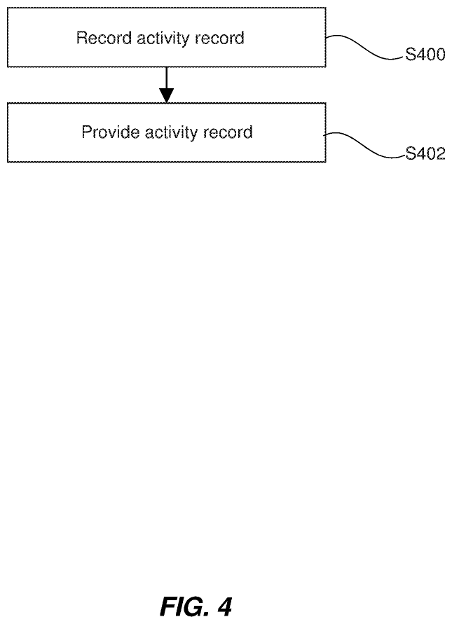

FIG. 4 is a flow diagram representing steps performed by the process executed according to an embodiment of the method for recording an activity of a user. The process may be a daemon, a service, a plugin or another process running, preferably in the background, on a workstation used by the user. The process causes the workstation to monitor the user's interaction with one predetermined software application which he or she uses for working on a given task. The process is also called a “sensor” or “sensor process” throughout the present disclosure. Multiple sensors, i.e. multiple instances of the process, may be executed on the workstation to monitor different functions of the software application and/or different kinds of interaction with the program, as explained further above. Likewise, multiple sensors may be run on the workstation to monitor different software applications for data generated by interaction with the user.

The process causes the computing system where it is executed to record (S400) an activity record characteristic of the usage, i.e. the interaction of the user with the respective monitored software application. The activity record comprises at least the following information: an identity of the user, a start timestamp representing a beginning of the usage, a duration figure associated with a time period of the usage (e.g. a stopping timestamp or a duration period equivalent thereto), an activity descriptor characteristic of the usage (e.g. “git branch”), an activity type characteristic of the software (e.g. an IDE having a git interface), and one or more artifact records each describing or comprising an artifact generated or edited during the usage (e.g. a file, a search key entered into a browser, etc.). The artifact record comprises an artifact descriptor representing an input to or an output of the software during the usage, and an artifact type representing a data type or an operation type associated with the input or output represented by the artifact descriptor.

In response to the ending of the usage, the activity record is provided (S402) for storage and/or further processing e.g. by the server process described before. In case of a client-server architecture this may include transferring the activity record via a communications network interconnecting the client (e.g. the user's workstation) and the server.

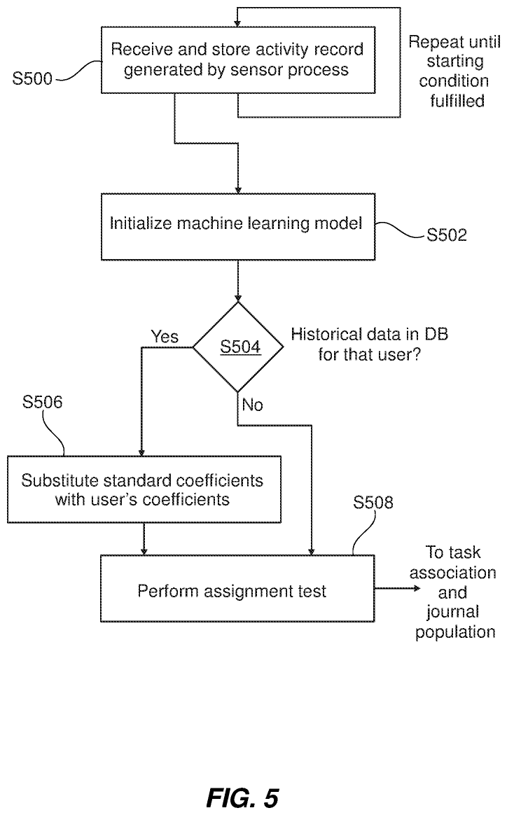

FIGS. 5-7 show a server-side sequence of flow diagrams representing an exemplary workflow embedding respective embodiments of the method for recording an activity of a user and the method for predicting a work progress figure for a user. FIG. 5 illustrates the recording of activity data and its evaluation using the machine learning model. The workflow starts with receiving and storing (S500) an activity record generated by a sensor process as described before. The activity is stored in an activity repository which is hosted e.g. by the server. Step S500 is repeated, i.e. the server continues to receive further activity records from one or more sensors monitoring the software used by the user.

When a starting condition is fulfilled (e.g. a predetermined processing time has been reached, or the number of activities in the activity repository has reached a predetermined threshold value), the machine learning model is initialized (S502) with standard coefficients previously obtained by training the model using a standard training set of activity records. For each user, a database is queried (S504) for a user-specific set of training coefficients. If a user-specific set exists, the machine learning model is updated (S506) to the user-specific coefficients received from the database to obtain a user-specific machine learning model which reflects the user's individual preferences of quantifying work progress. The user's preferences can be assessed during the assignment phase which is described further below.

The further description of FIGS. 5-7 considers merely an exemplary activity record which may be part of a plurality of activity records processed e.g. during the activity association described before.

Subsequently, the assignment test is performed (S508) as described before with the first input activity record being the exemplary activity record and the input sequence of activity records being the sequence of assigned activity records of a task received e.g. from an external task repository or generated as empty if the user's task repository is empty. Tasks of the user received from an external task repository may be stored in a dedicated internal task repository hosted by the server. As described below, the assignment test may be repeated (S508) for one or more further tasks in the task repository. In this way, one or more associated work progress figures are obtained from the model.

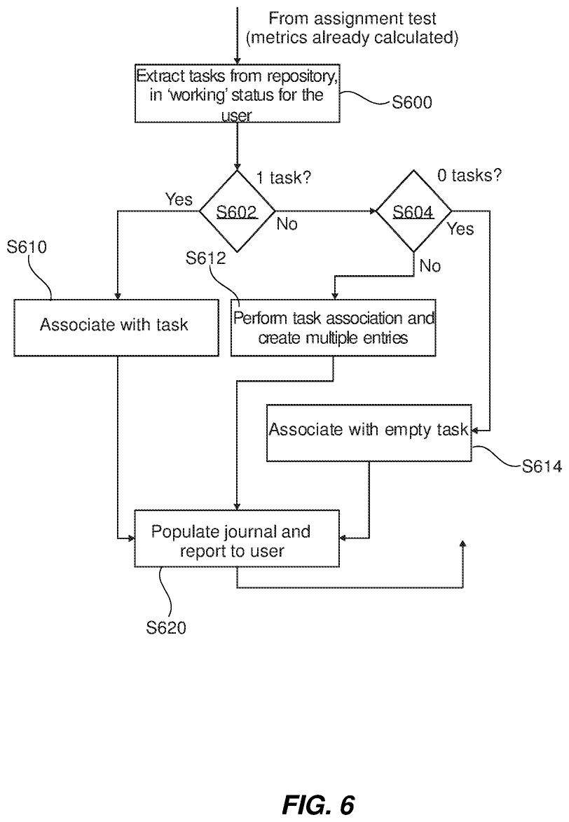

Upon completion of the assignment testing, the workflow continues with the task association phase illustrated by FIG. 6. This phase begins with extracting (S600) all relevant tasks (e.g. those tasks marked as “working” for the given user) e.g. from the external task repository. If (S602) the received task set comprises only one task, the exemplary activity record is associated (S610) with this task and the workflow continues (S620) with populating the user's task journal and transmitting the journal as a summary of the association carried out.

If (S602) the received task set does not comprise only one task, it is checked next (S604) whether the set is empty. If this is the case, an empty task is generated (S614) and the workflow continues (S620) with populating the user's task journal and transmitting the journal as a summary of the association carried out.

If (S604) the received task set is not empty, i.e. the received task set comprises multiple tasks, the previously described task association is performed (S612) so as to associate the exemplary activity with a task which has a highest probability (additionally contained in the metrics provided by the machine learning model) of assignment of the exemplary activity to its respective sequence of assigned activities. The workflow then continues (S620) with populating the user's task journal and transmitting the journal as a summary of the association carried out. In any case, step S620 includes delaying the transmission of the journal until any further activity records in the activity repository have been processed analogously.

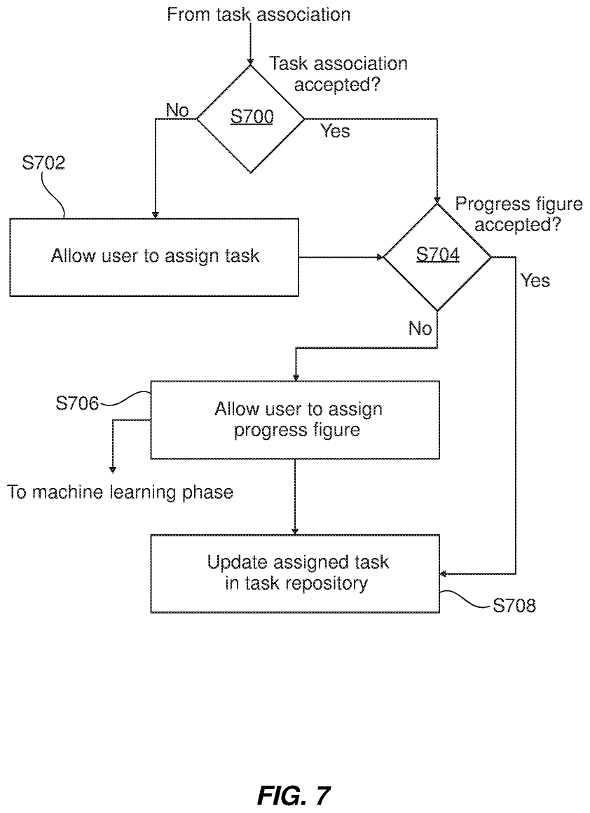

Upon completion of the task association, the workflow continues with the assignment phase illustrated by FIG. 7. The journal is displayed to the user for review of the associations carried out so far. If (S700), for the exemplary activity, the user does not accept the task with which the activity was associated, the user may assign (S702) the activity to a different task present in the journal or to a new task he or she adds to the journal. Otherwise, the association can be deemed correct and converts into a task assignment.

If (S704), for the exemplary activity, the user does not accept the progress figure obtained for the combination of the exemplary activity record with the sequence of assigned activity records of the assigned task, the user may assign (S706) a subjective work progress figure (e.g. a different percentage) to the assigned task. Step S706 includes providing a copy of at least the exemplary activity record, the sequence of assigned activity records of the assigned task, and the assigned subjective work progress figure to a process for retraining the machine learning model. The retraining process may include storing said data in a retraining set (e.g. a database) for performing the retraining at a later time.

If (S704) the user accepts the associated work progress figure, the association can be deemed correct and converts into an assignment, too. Eventually, the assigned task is updated (S708) by appending the exemplary activity record to its sequence of assigned activity records and by replacing the work progress figure of the assigned task with the newly assigned work progress figure. Step S708 also includes providing the updated associated task (probably together with further tasks which have been associated analogously to any further activities) to the external or official task repository, issue or task tracking system (such as GitLab, JIRA, RTC or the like).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for predicting a work progress figure for a user utilizing an assignment test, the method comprising:
receiving a first input activity record;
receiving an input sequence of activity records;
generating a test sequence, the test sequence comprising the input sequence and the first input activity record appended to the input sequence;
providing the test sequence to an input of a machine learning model;
receiving a metric from an output of the machine learning model in response to the provision of the test sequence, the metric comprising a work progress figure assigned to the test sequence;
providing the metric;
receiving a first unassigned activity record specific to the user;
receiving a first task specific to the user, the first task comprising a first sequence of assigned activity records; and
executing the assignment test with the first input activity record being the first unassigned activity record and the input sequence being the first sequence.

2. The method of claim 1, the metric further comprising a probability of correct association of the first input activity record with the input sequence.

3. The method of claim 2, wherein the user has assigned a task repository, the task repository comprising the first task and at least one second task, each second task comprising a second sequence of assigned activity records, the method comprising:
receiving a second input activity record;
determining a most likely task out of a first group formed by the first task and the at least one second task, wherein for the sequence of assigned activity records of the most likely task the probability of correct association of the second input activity record is highest;
associating with the most likely task the second input activity record and the work progress figure received for a combination of the most likely task and the second input activity record;
receiving the second task for each second task, and executing the assignment test with the first input activity record being the first unassigned activity record and the input sequence being the second sequence; and
executing a task association with the second input activity record being the first unassigned activity record.

4. The method of claim 3, wherein the association of the second input activity record and the work progress figure with the most likely task being performed only in case the probability of correct association of the second input activity record with the most likely task is greater than or equal to a predetermined threshold value.

5. The method of claim 3, wherein the user has assigned an activity repository, the activity repository comprising the first unassigned activity record and at least one second unassigned activity record, the method comprising:
receiving an unassociated activity record;
receiving the task and executing the assignment test with the first input activity record being the unassociated activity record and the input sequence being the sequence of assigned activity records comprised by the task, for each task out of the first group formed by the first task and the at least one second task;
executing the task association with the second input activity record being the unassociated activity record;
removing the unassociated activity record from the activity repository in response to associating the unassociated activity record;
removing the first unassigned activity record from the activity repository in response to associating the first unassigned activity record; and
performing the activity association with the unassociated activity record for each second unassigned activity record.

6. The method of claim 5, wherein the first unassigned activity record and each second unassigned activity record further comprise a timestamp, in response to completing the activity association for a second group formed by the first unassigned activity record and each second unassigned activity record, in case the activity repository comprises one or more remaining activity records out of the second group, the method comprising:
generating a sample task in the task repository;
using the timestamp for determining an earliest one of the remaining activity records;
assigning the earliest remaining activity record to the sample task;
executing the assignment test with the first input activity record being the earliest remaining activity record and the input sequence being an empty sequence;
removing the earliest remaining activity record from the activity repository; and
executing the activity association with the unassociated activity record being the remaining activity record in response to the removal of the earliest remaining activity record, for each remaining activity record in the activity repository.

7. The method of claim 5, wherein the first unassigned activity record and each second unassigned activity record further comprise a timestamp, the timestamp used for selecting an earliest one of the activity records in the activity repository as the first unassigned activity record, the performance of the activity association being executed in ascending temporal order of the second unassigned activity records, wherein the unassociated activity record is the second unassigned activity record.

8. The method of claim 3, further comprising:
submitting a summary of the task association of the first unassigned activity record to the user, the summary being descriptive of the first unassigned activity record and an associated task associated with the first unassigned activity record;
waiting for receiving a first verification information from the user, the first verification information being descriptive of an assignment of the first unassigned activity record to an assigned task;
re-associating the first unassigned activity record with the assigned task, in case of receiving the first verification information with the assigned task differing from the associated task;
appending the first unassigned activity record to the sequence of assigned activity records comprised by the associated task; and
assigning the work progress figure received for a combination of the sequence of assigned activity records comprised by the associated task and the first unassigned activity record to the associated task.

9. The method of claim 1, further comprising:
submitting a summary of the assignment test to the user, the summary being descriptive of the first unassigned activity record, the first task, and the work progress figure received for a combination of the first sequence and the first unassigned activity record;
waiting for receiving a second verification information from the user, the second verification information being descriptive of an assignment of a subjective progress figure to the combination of the first sequence and the first unassigned activity record;
updating said work progress figure to the value of the subjective progress figure, in case of receiving the second verification information with the subjective progress figure differing from said work progress figure.

10. The method of claim 9, wherein the user has assigned a task repository, the task repository comprising the first task, and wherein the method further comprises, in response to the update of the work progress figure received for a combination of the first sequence and the first unassigned activity record, receiving one or more training tasks from the task repository, the training tasks comprising the first task, and executing a learning algorithm on the training tasks for generating an updated machine learning model.

11. The method of claim 1, wherein the user has assigned a task repository, and wherein the method further comprises, in case the task repository is empty, generating a new task in the task repository, the new task comprising an empty sequence of activity records, the receipt of the first task comprising identifying the new task as the first task.

12. The method of claim 1, wherein the user has assigned a task repository, and wherein the method further comprises, in case the task repository comprises only the first task, associating the first unassigned activity record and the work progress figure with the first task.

13. The method of claim 12, wherein the metric further comprises a probability of correct association of the first input activity record with the input sequence, the association being performed only in case the probability of correct association of the first unassigned activity record with the first task is greater than or equal to a predetermined threshold value.

14. The method of claim 1, further comprising delaying the execution of the assignment test until a starting condition is fulfilled.

15. The method of claim 1, wherein the machine learning model comprising a recurrent neural network.

16. A computer-implemented method utilizing software for recording an activity of a user, the method comprising:
recording an activity record characteristic of the usage, the activity record comprising at least the following: an identity of the user, a start timestamp representing a beginning of the usage, a duration figure associated with a time period of the usage, an activity descriptor characteristic of the usage, an activity type characteristic of the software, and an artifact record, the artifact record comprising an artifact descriptor representing an input to or an output of the software during the usage, and an artifact type representing a data type or an operation type associated with the input or output represented by the artifact descriptor; and
providing the activity record, in response to the ending of the usage.

17. The method of claim 16, wherein the software comprises one of the following: an integrated development environment, an application programming interface, a graphical user interface builder, a compiler, a software testing tool, a debugger, a code profiler, a modeling tool, a shell, a version control software, a web browser, a word processor, an email client, a social media client, and a collaboration tool.

18. The method of claim 16, further comprising generating a multiplicity of activity records by repeating the recording for a multiplicity of usage events of the software, and merging the activity records into a merged activity record, the provision of the activity record comprising providing the merged activity record.

19. A computing system comprising a processor and a memory, the memory storing computer-executable instructions which, when executed by the processor, cause the processor to execute a method utilizing an assignment test for predicting a work progress figure for a user, the method comprising:
receiving a first input activity record;
receiving an input sequence of activity records;
generating a test sequence, the test sequence comprising the input sequence and the first input activity record appended to the input sequence;
providing the test sequence to an input of a machine learning model;
receiving a metric from an output of the machine learning model in response to the provision of the test sequence, the metric comprising a work progress figure assigned to the test sequence;
providing the metric;
receiving a first unassigned activity record specific to the user;
receiving a first task specific to the user, the first task comprising a first sequence of assigned activity records; and
executing the assignment test with the first input activity record being the first unassigned activity record and the input sequence being the first sequence.
